(19) United States
(12) Patent Application Publication
(10) Pub. No.: US 2017/0160924 A1
(43) Pub. Date: Jun. 8, 2017

(54) INFORMATION PROCESSING METHOD AND ELECTRONIC DEVICE

(71) Applicant: Lenovo (Beijing) Limited, Beijing (CN)

(72) Inventors: Qingdi Xie, Beijing (CN); Xiaobing Guo, Beijing (CN); Xiaoping Zhang, Beijing (CN); Xueyuan Zhang, Beijing (CN)

(21) Appl. No.: 15/372,698

(22) Filed: Dec. 8, 2016

(30) Foreign Application Priority Data
Dec. 8, 2015 (CN) 201510896737.0

(51) Int. Cl. G06F 3/0488; G06F 3/0489

(52) U.S. Cl. CPC G06F 3/04886; G06F 3/04883; G06F 3/04895

(57) ABSTRACT

For correcting an input operation performed on a virtual input unit, methods, apparatus, and computer program products are disclosed. The apparatus includes a display unit and a processor that presents a first key value in a display area on the display unit in response to receiving an input operation performed on a virtual input unit, detects a corrective operation performed on the virtual input unit, determines a second key value different than the first key value in response to detecting the corrective operation, and replaces the first key value with the second key value. In various embodiment, the apparatus includes a memory that stores code executable by the processor.

### CROSS-REFERENCE TO RELATED APPLICATIONS

This patent application claims priority to People's Republic of China Patent Application No. 201510896737.0 filed on 8 Dec. 2015 for Qingdi XIE, Xiaobing GUO, Xiaoping ZHANG, and Xueyuan ZHANG, the entire contents of which are incorporated herein by reference for all purposes.

### FIELD

The subject matter disclosed herein relates to the field of electronic technology, in particular to correcting an input operation performed on a virtual input unit.

### BACKGROUND

With the constant development of Internet technology and the increased popularity of electronic devices, such as mobile phones, computers and tablet PCs, people's lifestyles have changed significantly.

In the prior art, keyboards with touch trigger-type key value input have been employed in increasingly more electronic devices, such as computers and mobile phones. For example, the screen keyboard has advantages in terms of more attractive appearance and more convenience in use when compared to the traditional physical keyboard with protruding keys, so that the user can input by clicking or touching the corresponding key position area on the screen keyboard with their fingers.

However, when the screen keyboard in the electronic device is used for inputting the key value, and the output key value is not in line with the expectation, the user must delete the characters just entered, and then look for the key position area corresponding to the key value to be inputted, followed by re-operating in this area to complete the input of the desired key value.

### SUMMARY

An apparatus for correcting an input operation performed on a virtual input unit is disclosed. A method and computer program product also perform the functions of the apparatus.

A method for correcting an input operation performed on a virtual input unit includes presenting, by use of a processor, a first key value in a display area in response to receiving an input operation performed on a virtual input unit. The method also includes detecting a corrective operation performed on the virtual input unit. The method further includes determining a second key value different than the first key value in response to detecting the corrective operation and replacing the first key value with the second key value.

In some embodiments, determining a second key value different than the first key value in response to detecting the corrective operation includes identifying at least one key position adjacent to a first key position corresponding to the first key value and selecting a second key position meeting a preset condition from the at least one key position. Here the second key value corresponds to the second key position. In one embodiment, selecting a second key position meeting a preset condition from the at least one key position may include determining an operation position of the input operation and selecting a key position closest to the operation position as the second key position. In another embodiment, selecting a second key position meeting a preset condition from the at least one key position may include determining a usage frequency for each of the at least one key position and selecting a key position having the highest usage frequency as the second key position.

In certain embodiments, the corrective operation is a sliding operation. In such embodiments, selecting a second key position meeting a preset condition from the at least one key position may include determining a sliding direction of the sliding operation relative to a position of the first key position, determining a facing direction of each of the at least one key position relative to the position of the first key position, and selecting a key position having a facing direction that matches the sliding direction as the second key position.

In some embodiments, detecting a corrective operation performed on the virtual input unit includes identifying an operation position of the input operation and determining whether a predetermined gesture is received within a predetermined distance of the operation position. In certain embodiments, detecting a corrective operation performed on the virtual input unit includes determining whether a predetermined gesture is received within a predetermined area of the display area.

An apparatus for correcting an input operation performed on a virtual input unit includes a display unit and a processor that presents a first key value in a display area on the display unit in response to receiving an input operation performed on a virtual input unit, detects a corrective operation performed on the virtual input unit, determines a second key value different than the first key value in response to detecting the corrective operation, and replaces the first key value with the second key value. In various embodiments, the apparatus includes a memory that stores code executable by the processor.

In some embodiments, determining a second key value different than the first key value in response to detecting the corrective operation includes the processor identifying at least one key position adjacent to a first key position corresponding to the first key value and selecting a second key position meeting a preset condition from the at least one key position. Here the second key value corresponds to the second key position. In one embodiment, selecting a second key position meeting a preset condition from the at least one key position may include the processor determining an operation position of the input operation and selecting a key position closest to the operation position as the second key position. In another embodiment, selecting a second key position meeting a preset condition from the at least one key position may include the processor determining a usage frequency for each of the at least one key position and selecting a key position having the highest usage frequency as the second key position.

In certain embodiments, the corrective operation is a sliding operation. In such embodiments, selecting a second key position meeting a preset condition from the at least one key position may include the processor: determining a sliding direction of the sliding operation relative to a position of the first key position, determining a facing direction of each of the at least one key position relative to the position of the first key position, and selecting a key position having a facing direction that matches the sliding direction as the second key position.

In some embodiments, detecting a corrective operation performed on the virtual input unit includes the processor identifying an operation position of the input operation and determining whether a predetermined gesture is received within a predetermined distance of the operation position. In certain embodiments, detecting a corrective operation performed on the virtual input unit includes the processor determining whether a predetermined gesture is received within a predetermined area of the display area.

A program product for correcting an input operation performed on a virtual input unit includes a computer readable storage medium that stores code executable by a processor, the executable code including code to perform: presenting a first key value in a display area in response to receiving an input operation performed on a virtual input unit, detecting a corrective operation performed on the virtual input unit, determining a second key value different than the first key value in response to detecting the corrective operation, and replacing the first key value with the second key value.

In some embodiments, determining a second key value different than the first key value in response to detecting the corrective operation includes identifying at least one key position adjacent to a first key position corresponding to the first key value and selecting a second key position meeting a preset condition from the at least one key position, wherein the second key value corresponds to the second key position. In one embodiment, selecting a second key position meeting a preset condition from the at least one key position may include determining an operation position of the input operation and selecting a key position closest to the operation position as the second key position. In another embodiment, selecting a second key position meeting a preset condition from the at least one key position may include determining a usage frequency for each of the at least one key position and selecting a key position having the highest usage frequency as the second key position.

In certain embodiments, the corrective operation is a sliding operation. In such embodiments, selecting a second key position meeting a preset condition from the at least one key position may include determining a sliding direction of the sliding operation relative to a position of the first key position, determining a facing direction of each of the at least one key position relative to the position of the first key position, and selecting a key position having a facing direction that matches the sliding direction as the second key position. In certain embodiments, detecting a corrective operation performed on the virtual input unit includes determining whether a predetermined gesture is received within a predetermined area of the display area.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, embodiments will be described and explained with additional specificity and detail through the use of the accompanying drawings, in which:

FIG. 1 is a flow diagram showing one embodiment of a method for correcting an input operation performed on a virtual input unit;

FIG. 2a is a schematic diagram of a notebook computer with a virtual keyboard displayed at a first position;

FIG. 2b is a schematic diagram of a notebook computer with a virtual keyboard displayed at a second position;

FIG. 3 is a flow diagram of a specific implementation of determining a second key value responsive to detecting a corrective operation;

FIG. 4 is a flow diagram of a first specific implementation of selecting a second key position;

FIG. 5 is a flow diagram of a second specific implementation of selecting a second key position;

FIG. 6 is a flow diagram of a third specific implementation of selecting a second key position;

FIG. 7 is a schematic diagram showing one embodiment of the structure of an electronic device for correcting an input operation performed on a virtual input unit; and

FIG. 8 is a schematic diagram of the structure of one embodiment of a correction module.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine-readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The present disclosure describes systems, apparatus, and methods, used to solve the technical problems in the prior art of a complicated correction process and low efficiency in terms of correcting the input when modifying the inputted key value in the electronic device with a screen keyboard, thereby achieving technical effects including convenience and simplicity in correcting the inputted key value and high correction efficiency.

To solve these problems with unintended key presses, the embodiments of the present disclosure discuss presenting a first key value in a display area in response to receiving an input operation performed on a virtual input unit. The method also includes detecting a corrective operation performed on the virtual input unit. The method further includes determining a second key value different than the first key value in response to detecting the corrective operation and replacing the first key value with the second key value.

When a virtual input unit on the screen keyboard, such as the on-screen keyboard (“OSK”) of the electronic device, is used for inputting, an unintended key value may result (e.g., an unintended text, character, symbol, glyph, or sigil) if the user is a little off in pressing the desired key. This is analogous to a user missing a physical key (such as on a keyboard) at an edge of the top surface and instead pressing a nearby key. When the output key value does not meet the user's expectation, a corrective gesture may be performed at the virtual input unit to correct the undesired output key value.

In this way, a user of the electronic device with the OSK can conveniently, quickly, and efficiently correct the output key value not meeting the expectation. Beneficially, the disclosed corrective procedure prevents the tedious process of deleting the characters just inputted, looking for a key position area corresponding to the intended key value, and re-operating in this area. In one example, the corrective gesture may be a sliding operation.

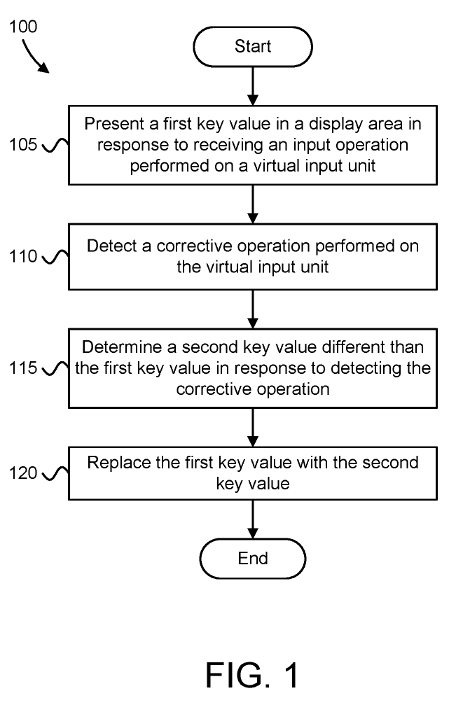

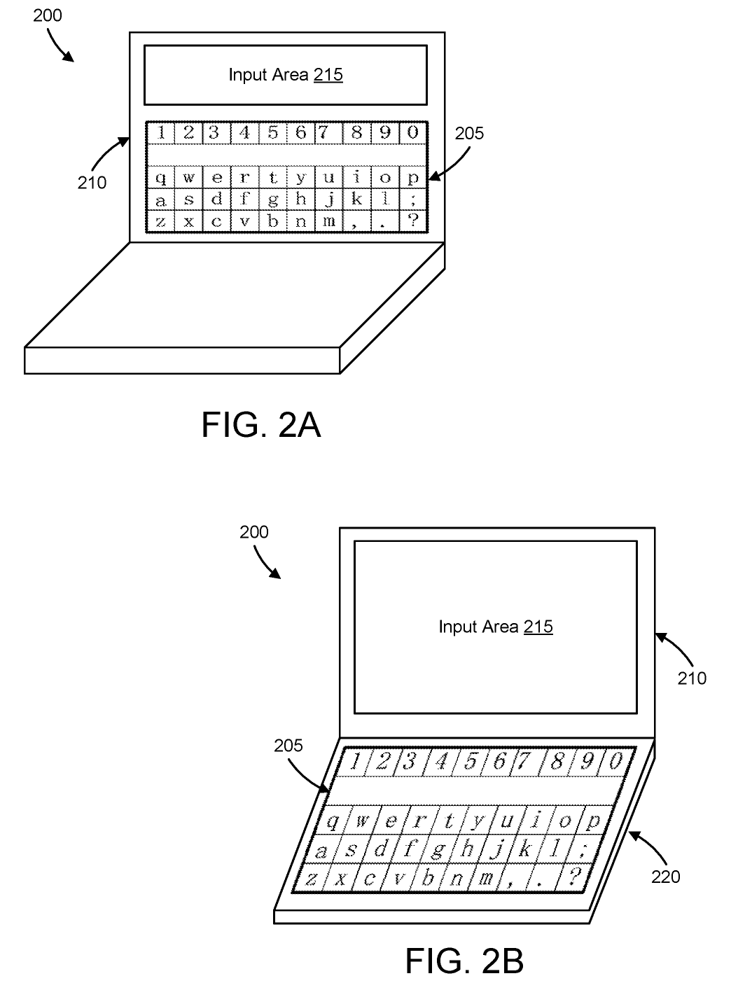

FIG. 1 illustrates a method 100 for correcting an input operation performed on a virtual input unit, according to embodiments of the disclosure. In one embodiment, the method 100 may be implemented by an electronic device having a virtual input unit, such as a mobile phone, a notebook computer, an iPad, and the like, or may also be other electronic devices used for inputting via a virtual keyboard. Examples of suitable electronic devices are discussed in further detail below with reference to FIGS. 2A-2B and 7-8. Alternatively, the method 100 may be performed by a processor and a computer readable storage medium. The computer readable storage medium may store code that is executed on the processor to perform the functions of the method 100.

The method 100 includes presenting 105 a first key value in a display area. In some embodiments, the display area may be part of a touchscreen that presents image data to a user and receives touch input from the user. Here, the first key value is specifically obtained in response to an input operation performed on the virtual input unit of the electronic device. For example, the user may press a virtual key or button on the touchscreen with the first key value being the value of the virtual key. Specifically, the electronic device may present a first key value in a display area, wherein the first key value is specifically obtained by responding to a key press or other input operation performed on a virtual input unit.

The method 100 also includes detecting 110 a corrective operation performed on the virtual input unit. The corrective operation may be any predefined gesture input by a user to correct an unintended key value quickly and efficiently, as described herein. In one embodiment, the corrective operation is a sliding gesture. To differentiate over other gestures recognizable on the electronic device, the corrective operation may be recognized only if performed in a predetermined area or within a predetermined distance of the key position corresponding to the unintended key value. In some embodiments, the corrective operation may require multiple fingers to perform.

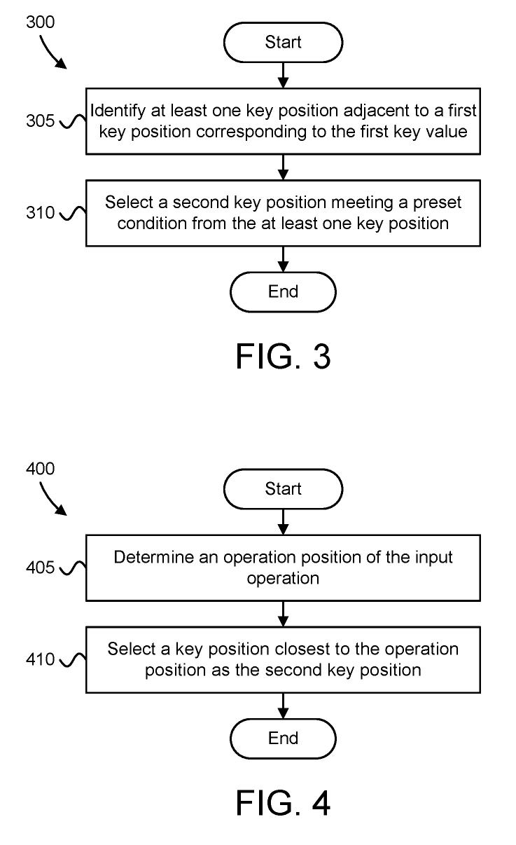

The method 100 includes determining 115 a second key value, different than the first key value, in response to detecting the corrective operation. The second key value corresponds to an intended key value. In some embodiments, the second key value is the key value of a key (e.g., second key) positioned adjacent to a key corresponding to the first key value (e.g., the first key). For example, the first key and the second key may share a border on the virtual input unit. Different ways for determining 115 a second key value are discussed below with reference to FIGS. 3-6.

The method 100 also includes replacing 120 the first key value with the second key value. For example, the display area may present the second key value in the display area. Further, the first key value may be replaced in a document being created/edited, a text field into which the user is inputting text, a dialog window, and the like.

FIGS. 2A and 2B illustrate the notebook computer 200 as an example of an electronic device with a virtual input unit 205. In one embodiment, the virtual input unit 205 is a virtual keyboard or other on-screen keyboard (“OSK”). FIG. 2A depicts an embodiment where the virtual input unit 205 includes an OSK displayed on a partial area in a first touch display screen 210 of the notebook computer 200. The notebook computer 200 also includes an input area 215 where text, characters, or symbols corresponding to the user input are displayed.

FIG. 2B depicts an embodiment where the virtual input unit 205 includes a virtual keyboard presented on a second touch display screen 220 dedicated to displaying the virtual keyboard, where the second touch display screen 220 is connected with the first touch display screen 210 of the notebook computer 200. Here, the notebook computer 200 also includes an input area 215 on the first touch display screen 210 where text, characters, or symbols corresponding to the user input are displayed. Examples of virtual keyboards include, but are not limited to, a SoftBoard™ screen keyboard, a MyTouch™ screen keyboard, and the like.

Referring to FIG. 2B, when a user uses the OSK (e.g., belonging to the virtual input unit 205) on the notebook computer 200 for input, the notebook computer 200 responds to this input (e.g., touching a virtual key) by determining a key value corresponding to a location (e.g., virtual key) on the OSK where the user touch occurs. The key value is displayed in the input area 215 on the first touch display screen 210 of the notebook computer 200. For example, when the user inputs a letter D in the fifth row of an active document (not shown) displayed on the first touch display screen 210 of the notebook computer 200 via the OSK, the notebook computer 200 will respond to the input of the letter D by inserting and displaying the letter D on the fifth row of the document. As another example, when the user inputs a letter K in a chat window (not shown) displayed on the first touch display screen 210 of the notebook computer 200 via the OSK, the letter K will be inserted and displayed at the position of the chat window.

However, when the user finds that the key value is not the key value they want to input after the notebook computer 200 displays the key value inputted via the OSK, the user may quickly and efficiently correct the key value through a corrective operation on the virtual input unit 205 of the notebook computer 200. In particular, when the user finds that the letter D displayed on the display screen is not the letter F they wanted to input after the notebook computer 200 displays the letter D inputted via the OSK on the fifth row of the document, the user can perform a corrective operation on the OSK to correct the letter D on the display screen, so the notebook computer will replace the unwanted letter D with the desired letter F. In some embodiments, the corrective operation performed on the virtual input unit 205 of the notebook computer 200 is different from other input operations. Further, the corrective operation avoids the need to deleted unwanted letter D, find the key position of the desired input key value on the OSK again, and then click or touch the desired letter F.

Certainly, there may be various reasons for the letter D that the user does not want to input being displayed on the display screen instead of the intended letter F. For example, the user may accidentally touch the key position of the letter D on the OSK by mistake rather than the key position of the letter F, which leads to the letter D being displayed. As another example, the area touched by the user on the OSK may include both a key position D and a key position F. Where more of the area occupied by the key position D is touched than the area occupied by the key position F, the notebook computer 200 may display the letter D, which is different from the letter F that the user wants to display. The aforementioned examples are for illustrative purposes only, and are not to be limitations on the types of typing errors that can be corrected using the described methods, apparatus, and systems.

In response to detecting the corrective operation (e.g., a predefined gesture or other predetermined input at the virtual input unit 205), then notebook computer 200 determines a second key value (different from the first key value) and replaces the first key value with a second key value, including displaying the second key value in the display area. Using the above examples, the notebook computer 200 determines that the letter F is the desired key value (e.g., the second key value) and replaces the letter D (the first key value) with the letter F (the second key value).

In some embodiments, the corrective operation is a sliding operation. Referring to FIGS. 1 and 2B, the detecting 110 a corrective operation performed on the virtual input unit may include determining whether the corrective operation is the predefined sliding operation. Accordingly, the notebook computer 200 judges whether touch input received after the user pressed the letter D is a sliding operation conforming to the corrective operation.

In certain embodiments, there may be an area specially arranged on the OSK to modify the prior input. Accordingly, the corrective operation can be performed in the specially arranged area and the notebook computer 200 will determine whether the touch operation performed on the specially arranged area on the OSK is the predefined sliding operation (e.g., the corrective operation). In other embodiments, there is no area specially arranged on the OSK to modify the prior input. In such embodiments, the corrective operation may be detected when the sliding operation (or other predefined gesture) is performed within a certain range (e.g., a predetermined distance) of the prior input position. In one embodiment, the certain range is based on the size of each key value displayed on the OSK. Referring to FIGS. 1 and 2B, the detecting 110 a corrective operation performed on the virtual input unit may include determining whether the initial position of the corrective operation is within the preset range of the first operation position and, if so, determining whether the corrective operation is the predefined sliding operation.

For example, the preset range may be 5 mm, and the notebook computer 200 may determine whether a touch input (e.g., a gesture) is within 5 mm of the operation point of the first operation (e.g., the key press of the letter D). If the touch input is within the preset 5 mm range, then the notebook computer 200 determines whether the touch input is the predefined sliding operation. As will be appreciated by one of skill in the art, the preset range can be flexibly selected and the specially arranged flexibly located on the virtual input unit 205, for example based on the screen keyboard type. Accordingly, the above examples are illustrative only and not to limit the notebook computer 200 detecting 110 a corrective operation performed on the virtual input unit.

FIG. 3 illustrates a method 300 for determining the second key value in response to detecting the corrective operation. The method 300 may be implemented using an electronic device (such as the notebook computer 200), a processor executing code stored in a computer readable memory, and the like. In one embodiment, the method 300 implements the step 115 of determining the second key value in response to detecting the corrective operation described above with reference to FIG. 1.

The method 300 includes identifying 305 at least one key position adjacent to a first key position corresponding to the first key value. Continuing the above example, the notebook computer 200 may determine at least one key position adjacent to the letter D displayed on the current display screen. The key position F, the key position S, the key position E, and the key position C are all adjacent to the key position D, as shown in FIG. 2B. In another scenario, the first key value may be the number 1, and the key position adjacent to the key position 1 corresponding to the data 1 in the OSK of FIG. 2B is only the key position 2. In this scenario, the notebook computer will determine a key position adjacent to the key position 1 corresponding to the data 1, that is, the key position 2.

Referring to FIG. 3, the method 300 includes selecting 310 a second key position meeting a preset condition from the at least one key position, where the second key value discussed above with reference to FIG. 1 is the key value corresponding to the selected second key position. Returning to the earlier example, after determining the key position F, the key position S, the key position E, and the key position C adjacent to the key position D, the notebook computer 200 identifies a key position in line with the preset condition from among the candidates: key position F, key position S, key position E, and key position C.

FIGS. 4-6 discuss various methods for selecting 310 a second key position meeting a preset condition. FIG. 4 illustrates a method 400 for selecting a second key position meeting a preset condition, including: determining 405 an operation position of the input operation and selecting 410 a key position closest to the operation position as the second key position. As discussed above, the method 400 may be one implementation of the step 310 of selecting a second key position meeting a present condition, described above with reference to FIG. 3.

In one embodiment, determining 405 an operation position of the input operation may include determining each key position from the at least one key position, and identifying at least one position. Here, the method 400 identifies at least one position corresponding to a neighboring key of the unintentionally pressed key. In one embodiment, selecting 410 a key position closest to the operation position as the second key position includes determining a second position closest to the first position from the at least one position and matching the second position to a key position. The method 400 may be implemented using an electronic device (such as the notebook computer 200), a processor executing code stored in a computer readable memory, and the like.

Continuing the above example, the notebook computer 200, after determining the key position F, the key position S, the key position E, and the key position C as being adjacent to the key position D, then determines the positions of these key positions on the OSK. Herein, assuming that the position of the key position F on the OSK is the position 2, the position of the key position S on the OSK is the position 3, the position of the key position E on the OSK is the position 4, and the position of the key position C on the OSK is the position 5; then, the notebook computer 200 will also determine the clicking or touching position when the user inputs the key position D on the OSK.

Herein, assuming that the operation position (e.g., the clicking or touching position of the key position on the OSK) is the position 1, then the notebook computer 200 will respectively calculate the distance between each of the positions 2-5 to the position 1. In this example, assume that the distance between the position 2 and the position 1 is 0.5 cm, the distance between the position 3 and the position 1 is 0.6 cm, the distance between the position 4 and the position 1 is 0.7 cm, and the distance between the position 5 and the position 1 is 0.65 cm. Next, the notebook computer 200 identifies the closest position to the position 1 from these calculated distances; specifically, the notebook computer will determine that the position 2 is closest to the position 1. Therefore, the notebook computer 200 selects the position 2 (corresponding to the key position F) as the closest to the operation position (e.g., touching the key position D), such that the key value F corresponding to the key position F is used to replace the key value D, and the key value F is displayed at the position currently displaying the key value D on the display screen. The notebook computer 200 further displays the letter F at the position of line 5 in the document of the display in this example.

Thus, the key values displayed on the notebook computer that are not in line with the expectation can be corrected conveniently, quickly, and efficiently by performing the preset sliding operation via the virtual keyboard across the OSK on the notebook computer. Accordingly, it is unnecessary to delete the characters just inputted, look for a key position area corresponding to the key value to be inputted on the OSK, and then operate in the area again to complete the input of key value when the output key values are not in line with the expectation, thereby improving convenience and simplicity in correcting the inputted key value and providing increased correction efficiency.

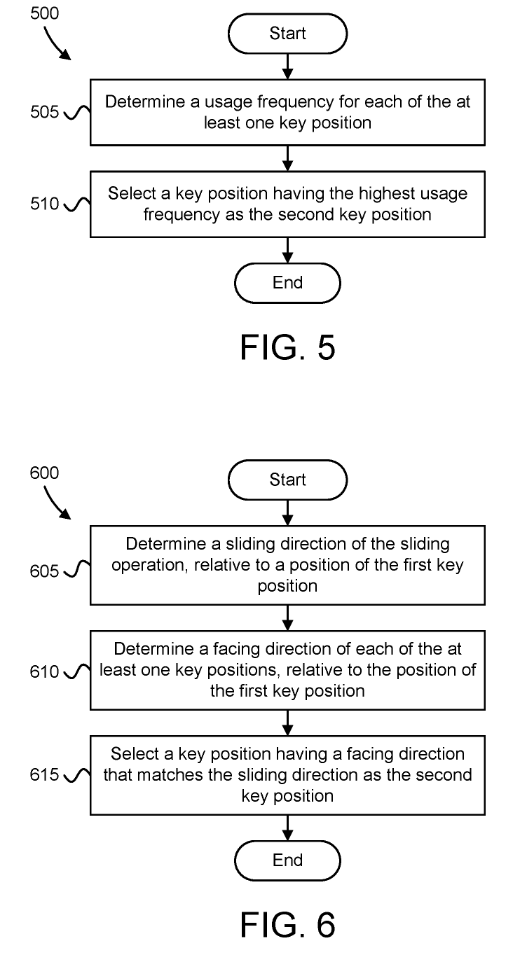

FIG. 5 illustrates a method 500 for selecting a second key position meeting a preset condition, including: determining 505 a usage frequency for each of the at least one key position and selecting 510 a key position having the highest usage frequency as the second key position. In one embodiment, selecting 510 a key position having the highest usage frequency as the second key position includes determining a maximum usage frequency value from the at least one usage frequency and selecting the key position corresponding to the maximum usage frequency value from the at least one key position. The method 500 may be implemented using an electronic device (such as the notebook computer 200), a processor executing code stored in a computer readable memory, and the like. As discussed above, the method 500 may be one implementation of the step 310 of selecting a second key position meeting a present condition, described above with reference to FIG. 3.

Continuing the above example, the notebook computer 200, after determining the key position F, the key position S, the key position E, and the key position C to be adjacent to the key position D, the notebook computer 200 determines the usage frequency of these key positions according to the historical data recorded by the notebook computer 200. Herein, assuming that the usage frequency of the key position F is 100, the usage frequency of the key position S is 200, the usage frequency of the key position E is 150 and usage frequency of the key position C is 10, then the notebook computer can determine that the one with the maximum usage frequency among these key positions is the key position S. Therefore, the notebook computer can determine the key position corresponding to the highest usage frequency is the key position S. Therefore, the notebook computer 200 selects the key value S corresponding to the key position S to replace the key value D, and the key value S is displayed at the position currently displaying the key value D on the display screen. The notebook computer 200 further displays the letter S at the position of line 5 in the document of the display in this embodiment.

In certain embodiments, the second key position may be selected using a combination of distance to the operation position and usage frequency. For example, the usage frequency values may be weighted according to a distance between the key position and the operation position, with closer key position given greater weight. These weighted values may then be compared to determine a highest weighted usage frequency. As anther example, the distance between the key positions the operation position may be weighted according to usage frequency values, with key positions having greater usage frequencies being given shorted weighted distances. These weighted values may then be compared to determine a closest weighted distance.

FIG. 6 illustrates a method 600 for selecting a second key position meeting a preset condition, including: determining 605 a sliding direction of the sliding operation, relative to a position of the first key position, determining 610 a facing direction of each of the at least one key positions, relative to the position of the first key position, and selecting 615 a key position having a facing direction that matches the sliding direction as the second key position. As discussed above, the method 600 may be one implementation of the step 310 of selecting a second key position meeting a present condition, described above with reference to FIG. 3. The method 600 may be implemented using an electronic device (such as the notebook computer 200), a processor executing code stored in a computer readable memory, and the like.

Continuing the above example, the notebook computer 200, after determining the key position F, the key position S, the key position E, and the key position C to be adjacent to the key position D, the notebook computer 200 determines the directions of these key positions with respect to the position of the key position D on the OSK. For example, as shown in FIG. 2B, the direction of the position of the key position F with respect to the position of the key position D on the OSK is rightward, the direction of the position of the key position S with respect to the position of the key position D on the OSK is leftward, the direction of the position of the key position E with respect to the position of the key position D on the OSK is upward, and the direction of the position of the key position C with respect to the position of the key position D on the OSK is downward.

The notebook computer 200 also determines the direction with respect to the key position D when the user performs the sliding operation on the OSK. Herein, assuming that the direction of the sliding operation with respect to the key position D is leftward, then the notebook computer will know that the key position S is consistent with the direction of the sliding operation with respect to the key position D. Therefore, the notebook computer can determine the key position corresponding to the sliding operation is the key position S. Therefore, the notebook computer 200 selects the key value S corresponding to the key position S to replace the key value D, and the key value S is displayed at the position currently displaying the key value D on the display screen. The notebook computer 200 further displays the letter S at the position of line 5 in the document of the display, in this example.

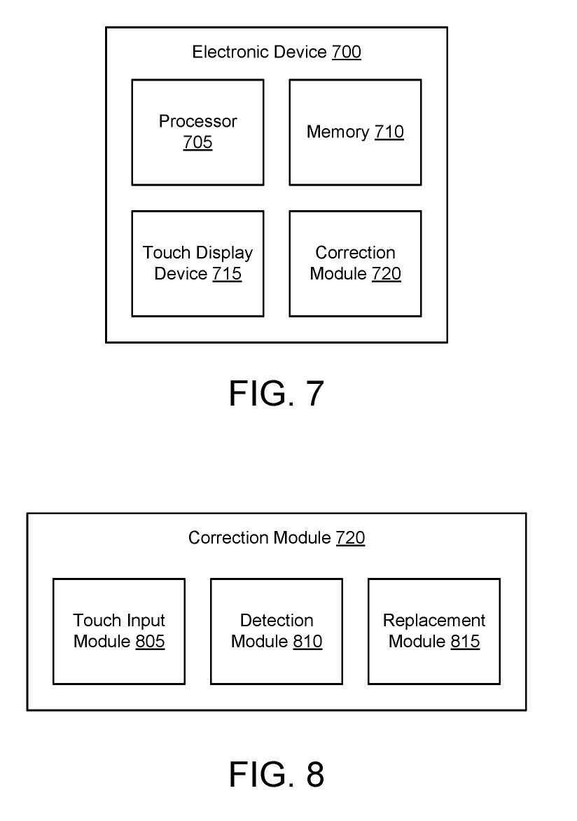

FIG. 7 depicts an electronic device 700 for correcting an input operation performed on a virtual input unit, according to embodiments of the disclosure. As depicted, the electronic device 700 includes a processor 705, a memory 710, a touch display device 715, and a correction module 720. In some embodiments, the electronic device 700 is a computing device, such as a smartphone, mobile phone, personal digital assistant (“PDA”), tablet computer, laptop computer, desktop computer, personal computer, mainframe, server, terminal station, and the like.

The processor 705, in one embodiment, may comprise any known controller capable of executing computer-readable instructions and/or capable of performing logical operations. For example, the processor 705 may be a microcontroller, a microprocessor, a central processing unit (CPU), a graphics processing unit (GPU), an auxiliary processing unit, a FPGA, an integrated circuit, or similar controller. In certain embodiments, the processor 705 may include multiple processing units, such as multiple processing cores, multiple CPUs, multiple microcontrollers, or the like.

In some embodiments, the processor 705 executes instructions stored in the memory 710 to perform the methods and routines described herein. The processor 705 is communicatively coupled to the memory 710, the touch display device 715, and the correction module 720. In various embodiments, the processor 705 may be communicatively coupled to a network interface, transceiver, or similar means for communicating with another electronic device (not shown).

In some embodiments, the processor 705 identifies an operation position of the input operation and determines whether a predetermined gesture is received within a predetermined distance of the operation position. In certain embodiments, the processor determines 705 whether a predetermined gesture is received within a predetermined area of the display area. In some embodiments, the processor 705 identifies at least one key position adjacent to a first key position corresponding to the first key value and selects a second key position meeting a preset condition from the at least one key position. Here the second key value corresponds to the second key position.

In one embodiment, the processor 705 selects a second key position meeting a preset condition from the at least one key position by determining an operation position of the input operation and selecting a key position closest to the operation position as the second key position. In another embodiment, the processor 705 selects a second key position meeting a preset condition from the at least one key position by determining a usage frequency for each of the at least one key position and selecting a key position having the highest usage frequency as the second key position.

In certain embodiments, the processor determines whether a user input is a sliding operation corresponding to the corrective operation. In such embodiments, the processor 705 determines a sliding direction of the sliding operation relative to a position of the first key position, determines a facing direction of each of the at least one key position relative to the position of the first key position, and selects a key position having a facing direction that matches the sliding direction as the second key position.

The memory 710, in one embodiment, is a computer readable storage medium. In some embodiments, the memory 710 includes volatile computer storage media. For example, the memory 710 may include a random access memory (RAM), including dynamic RAM (DRAM), synchronous dynamic RAM (SDRAM), and/or static RAM (SRAM). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data relating to correcting an input operation performed on a virtual input unit. For example, the memory 710 may store an operation position, a usage frequency, a key position, and the like. In some embodiments, the memory 710 also stores executable code and related data, such as an operating system or other controller algorithms operating on the electronic device 700. Further, the memory 710 may store code for one or more target applications operating on the electronic device 700.

The touch display device 715, in one embodiment, includes a touch input panel collocated with a display panel capable of outputting visual data to a user. In some embodiments, text may be input using a virtual keyboard displayed on the touch display device 715 and/or by handwriting on the touch display device 715. The display panel may be any electronic display. For example, the touch display device 715 may include, but is not limited to, an LCD display, an LED display, an OLED display, a projector, or similar display device capable of outputting images, text, or the like to a user. As another, non-limiting, example, the touch display device 715 may include a wearable display such as a smart watch, smart glasses, a heads-up display, or the like. Further, the touch display device 715 may be a component of a smart phone, a personal digital assistant, a television, a table computer, a notebook (laptop) computer, a personal computer, a vehicle dashboard, or the like.

The touch display device 715 may also be designed to output audible and/or haptic signals. In certain embodiments, the touch display device 715 includes one or more speakers for producing sound. For example, the touch display device 715 may produce an audible alert or notification (e.g., a beep or chime). In some embodiments, the touch display device 715 includes one or more haptic devices for producing vibrations, motion, or other haptic feedback.

In some embodiments, the electronic device 700 may include one or more input devices in addition to the touch display device 715. For example, the electronic device 700 may include a button, a keyboard, a stylus, a microphone, or the like. In some embodiments, the electronic device 700 may include one or more output devices in addition to the touch display device 715. For example, the electronic device 700 may include a speaker, a haptic device, a stylus, a microphone, or the like. Further, the electronic device may be communicatively coupled to a remote input/output device such as a headphone, headset, handset, earphone, earpiece, eyepiece, or similar device located remotely and/or separable from the rest of electronic device 700.

The correction module 720, in one embodiment, presents a first key value in a display area on the display unit in response to receiving an input operation performed on a virtual input unit, detects a corrective operation performed on the virtual input unit, determines a second key value different than the first key value in response to detecting the corrective operation, and replaces the first key value with the second key value. The correction module 720 may be embodied by computer hardware, computer software, or a combination of computer hardware and computer software. Embodiments of the correction module 720 are discussed below with reference to FIG. 8.

FIG. 8 illustrates a block diagram of a correction module 720, according to embodiments of the invention. The correction module 720 may be used to implement the method 100 discussed above with reference to FIG. 1. As depicted, the correction module 720 may include a touch input module 805, used for presenting a first key value in a display area, wherein the first key value is specifically obtained by responding to a first operation performed on a virtual input unit of the electronic device.

The correction module 720 also includes a detection module 810, used for detecting a corrective operation performed on the virtual input unit. The correction module 720 further includes a replacement module 815, used for determining a second key value different than the first key value in response to detecting the corrective operation and replacing the first key value with the second key value. In certain embodiments, the replacement module 815 may be used to implement the methods 300-600 discussed above with reference to FIGS. 3-6.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An method comprising:
presenting, by use of a processor, a first key value in a display area in response to receiving an input operation performed on a virtual input unit;
detecting a corrective operation performed on the virtual input unit;
determining a second key value different than the first key value in response to detecting the corrective operation; and
replacing the first key value with the second key value.

2. The method of claim 1, wherein determining a second key value different than the first key value in response to detecting the corrective operation comprises:
identifying at least one key position adjacent to a first key position corresponding to the first key value; and
selecting a second key position meeting a preset condition from the at least one key position, wherein the second key value corresponds to the second key position.

3. The method of claim 2, wherein selecting a second key position meeting a preset condition from the at least one key position comprises:
determining a first position of an operation position of the input operation; and
selecting a key position closest to the operation position as the second key position.

4. The method of claim 2, wherein selecting a second key position meeting a preset condition from the at least one key position comprises:
determining a usage frequency for each of the at least one key position; and
selecting a key position having the highest usage frequency as the second key position.

5. The method of claim 2, wherein the corrective operation is a sliding operation, wherein selecting a second key position meeting a preset condition from the at least one key position comprises:
determining a sliding direction of the sliding operation relative to a position of the first key position;
determining a facing direction of each of the at least one key position relative to the position of the first key position; and
selecting a key position having a facing direction that matches the sliding direction as the second key position.

6. The method of claim 1, wherein detecting a corrective operation performed on the virtual input unit comprises:
identifying an operation position of the input operation; and
determining whether a predetermined gesture is received within a predetermined distance of the operation position.

7. The method of claim 1, wherein detecting a corrective operation performed on the virtual input unit comprises determining whether a predetermined gesture is received within a predetermined area of the display area.

8. An electronic device, comprising:
a display unit;
a processor; and
a memory that stores code executable by the processor to:
present a first key value in a display area on the display unit in response to receiving an input operation performed on a virtual input unit;
detect a corrective operation performed on the virtual input unit;
determine a second key value different than the first key value in response to detecting the corrective operation; and
replace the first key value with the second key value.

9. The electronic device of claim 8, wherein determining a second key value different than the first key value comprises the processor:
identifying at least one key position adjacent to a first key position corresponding to the first key value; and
selecting a second key position meeting a preset condition from the at least one key position, wherein the second key value corresponds to the second key position.

10. The electronic device of claim 9, wherein selecting a second key position meeting a preset condition from the at least one key position comprises the processor:
determining an operation position of the input operation; and
selecting a key position closest to the operation position as the second key position.

11. The electronic device of claim 9, wherein selecting a second key position meeting a preset condition from the at least one key position comprises the processor:
determining a usage frequency for each of the at least one key position; and
selecting a key position having the highest usage frequency as the second key position.

12. The electronic device of claim 9, wherein the corrective operation is a sliding operation, wherein selecting a second key position meeting a preset condition from the at least one key position comprises the processor:
determining a sliding direction of the sliding operation relative to a position of the first key position;
determining a facing direction of each of the at least one key positions relative to the position of the first key position; and
selecting a key position having a facing direction that matches the sliding direction as the second key position.

13. The electronic device of claim 8, wherein detecting a corrective operation performed on the virtual input unit comprises the processor:
identifying an operation position of the input operation; and
determining whether a predetermined gesture is received within a predetermined distance of the operation position.

14. The electronic device of claim 8, wherein detecting a corrective operation performed on the virtual input unit comprises the processor determining whether a predetermined gesture is received within a predetermined area of the display area.

15. A program product comprising a computer readable storage medium that stores code executable by a processor, the executable code comprising code to perform:
presenting a first key value in a display area in response to receiving an input operation performed on a virtual input unit;
detecting a corrective operation performed on the virtual input unit;
determining a second key value different than the first key value in response to detecting the corrective operation; and
replacing the first key value with the second key value.

16. The program product of claim 15, wherein determining a second key value different than the first key value in response to detecting the corrective operation comprises:
identifying at least one key position adjacent to a first key position corresponding to the first key value; and
selecting a second key position meeting a preset condition from the at least one key position, wherein the second key value corresponds to the second key position.

17. The program product of claim 16, wherein selecting a second key position meeting a preset condition from the at least one key position comprises:
determining an operation position of the input operation; and
selecting a key position closest to the operation position as the second key position.

18. The program product of claim 16, wherein selecting a second key position meeting a preset condition from the at least one key position comprises:
determining a usage frequency for each of the at least one key position; and
selecting a key position having the highest usage frequency as the second key position.

19. The program product of claim 16, wherein the corrective operation is a sliding operation, wherein selecting a second key position meeting a preset condition from the at least one key position comprises:
determining a sliding direction of the sliding operation relative to a position of the first key position;
determining a facing direction of each of the at least one key position relative to the position of the first key position; and
selecting a key position having a facing direction that matches the sliding direction as the second key position.

20. The program product of claim 15, wherein detecting a corrective operation performed on the virtual input unit comprises determining whether a predetermined gesture is received within a predetermined area of the display area.
